(19) United States
(12) Patent Application Publication
(10) Pub. No.: US 2026/0313630 A1
(43) Pub. Date: Oct. 8, 2026

(54) METHOD AND APPARATUS FOR SEMI-PERSISTENT SCHEDULING IN WIRELESS COMMUNICATION

(71) Applicant: Apogee 5G Global, LLC, Plano, TX (US)

(72) Inventors: Qi JIANG, Shanghai (CN); Xiaobo ZHANG, Shanghai (CN)

(73) Assignee: Apogee 5G Global, LLC, Plano, TX (US)

(21) Appl. No.: 19/134,967

(22) PCT Filed: Nov. 13, 2023
(86) PCT No.: PCT/CN2023/131169

§ 371 Date: Jun. 15, 2026

(30) Foreign Application Priority Data
Dec. 2, 2022 (CN) 202211541098.2

(51) Int. Cl. H04W 72/11; H04W 72/23

(52) U.S. Cl. CPC H04W 72/11; H04W 72/23

(57) ABSTRACT

Disclosed in the present application are a method and apparatus used in a node for wireless communication. The method comprises: a user equipment (UE) receiving a first information block used for configuring a first semi-persistent transmission. The first semi-persistent transmission corresponds to a first codeword group comprising a first codeword and a second codeword. The UE receives a first signaling used for releasing scheduling corresponding to at least the second codeword in the first codeword group corresponding to the first semi-persistent transmission. The first signaling comprises a first domain set used for confirming a Physical Downlink Control Channel (PDCCH) released for scheduling corresponding to at least the second codeword in the first codeword group corresponding to the first semi-persistent transmission. The first domain set is associated with the first codeword and the second codeword.

### TECHNICAL FIELD

The present application relates to transmission methods and apparatuses in wireless communication systems, in particular to transmission solutions and apparatuses for semi-persistent scheduling in wireless communication.

### BACKGROUND ART

A 5G wireless cellular communication network system (5G-RAN) enhances a grant-free transmission (Grant Free) mode of UE (User Equipment) on the basis of original LTE (Long-Term Evolution). A downlink SPS (Semi-Persistent) transmission is achieved in a mode of an RRC (Radio Resource Control) configuration combined with PDCCH (Physical Downlink Control Channel) activation, while uplink configured grant supports two modes including RRC configuration (Type 1) and RRC configuration combined with PDCCH activation (Type 2) at the same time. In a design of NR Rel-16, a mode that multiple sets of downlink/uplink grant-free scheduling configurations are activated/released by the same PDCCH is further supported to further improve the efficiency.

In discussions of NR R17 and R18, a scenario of configuring multiple panels on a terminal side has been adopted, and a transmission mode of sending multiple CWs (Codewords) on the terminal side is also supported at the same time. Therefore, the impact of the introduction of the above new solution on the configured grant transmission also needs to be considered accordingly.

### SUMMARY OF THE INVENTION

For a future R18 system, sending of a terminal is enhanced. One of the important aspects is the introduction of two Panels. The terminal can use two Panels to send on two sending beams at the same time, to obtain better spatial diversity/multiplexing gains, and the above transmission mode also can be used in an uplink configured grant transmission. Meanwhile, the terminal also can receive the transmission of two codewords for one SPS configuration from a base station through two Panels at the same time. How to optimize existing SPS and configuration grant activation and release modes will be a problem that needs to be considered.

In response to the above-mentioned problem of semi-persistent scheduling in a multi-panel scenario, the present application discloses a solution. It should be noted that in the description of the present application, a two-codeword transmission is only used as a typical application scenario or example; the present application is also applicable to other scenarios facing similar problems, for example, the scenario of single-codeword transmission, or for different technical fields, such as other technical fields excluding PDCCH activation and release, for example, the measurement reporting field, an uplink data transmission and other technical fields to achieve similar technical effects. In addition, adopting a unified solution in different scenarios (including but not limited to the scenario of two-codeword transmission) also helps reduce the hardware complexity and costs. In case of no conflict, the embodiments and features in the embodiments in any node of the present application can be applied to any other node. In case of no conflict, the embodiments and the features in the embodiments in the present application can be arbitrarily combined with each other. In particular, the explanations of the terminology, nouns, functions, and variables in the present application (if not specified) can refer to the definitions in the TS36 series, TS38 series, and TS37 series of the specification protocol of 3GPP. If required, reference can be made to 3GPP standards TS38.211, TS38.212, TS38.213, TS38.214, TS38.215, TS38.321, TS38.331, TS38.305, TS37.355 to assist in the understanding of the present application.

The present application discloses a method used in a first node for wireless communication, comprising:
receiving a first information block, wherein the first information block is used for configuring a first semi-persistent transmission, the first semi-persistent transmission corresponds to a first codeword group, and the first codeword group comprises a first codeword and a second codeword;
and receiving first signaling, wherein the first signaling is used for releasing scheduling corresponding to at least the second codeword in the first codeword group corresponding to the first semi-persistent transmission,
wherein the first signaling comprises a first field set, the first field set is used for PDCCH validation of scheduling release corresponding to at least the second codeword in the first codeword group corresponding to the first semi-persistent transmission; and the first field set is associated with the first codeword and the second codeword.

As one embodiment, the above method is characterized in that: when a terminal supports a semi-persistent transmission of two codewords, at least one of the two codewords can be released independently to ensure the transmission flexibility.

According to one aspect of the present application, the first field set comprises a first field; when a first condition is met, PDCCH validation of scheduling release corresponding to only the second codeword in the first codeword group corresponding to the first semi-persistent transmission is achieved; when a second condition is met, PDCCH validation of scheduling release corresponding to the first codeword and PDCCH validation of scheduling release corresponding to the second codeword corresponding to the first semi-persistent transmission are both achieved; the first condition comprises: the first field included in the first field set is equal to a first value; and the second condition comprises: the first field included in the first field set is equal to a second value.

As one embodiment, the above method is characterized in that: one field in the first field set is used to achieve scheduling release validation of two codewords to reduce signaling overhead.

According to one aspect of the present application, the first field set comprises a first field and a second field; when a third condition is met, PDCCH validation of scheduling release corresponding to the first codeword and PDCCH validation of scheduling release corresponding to the second codeword corresponding to the first semi-persistent transmission are both achieved; when a fourth condition is met, PDCCH validation of scheduling release corresponding to only the second codeword in the first codeword group corresponding to the first semi-persistent transmission is achieved; the third condition comprises: the first field and the second field included in the first field set are equal to a first value and a second value, respectively; and the fourth condition comprises: the first field included in the first field set is equal to a first value and the second field is not equal to a second value.

As one embodiment, the above method is characterized in that: two fields in the first field set are used to achieve scheduling release validation of two codewords, so as to ensure the forward compatibility.

According to one aspect of the present application, the second codeword is predefined in the first codeword group, or high-layer signaling is used for determining the second codeword from the first codeword group.

As one embodiment, the above method is characterized in that: the operating of the second codeword is more flexible than that of the first codeword.

According to one aspect of the present application, the first signaling comprises a target field, the target field is used for indicating a first index set, the first index set comprises a first index, and the first semi-persistent transmission configured by the first information block is associated with the first index; and the first index set is associated with K1 semi-persistent transmissions, and the first signaling is used for releasing scheduling corresponding to at least one codeword in the first codeword group corresponding to any semi-persistent transmission in the K1 semi-persistent transmissions.

As one embodiment, the above method is characterized in that: the first semi-persistent transmission corresponds to the first index, and multiple semi-persistent transmissions are released at the same time to reduce the signaling overhead and improve the efficiency.

According to one aspect of the present application, comprising:
abandoning receiving at least a second signal in a first signal and the second signal,
wherein the first semi-persistent transmission configured by the first information block comprises the first signal and the second signal, the first signal corresponds to the first codeword, and the second signal corresponds to the second codeword; when the first signaling is used for releasing scheduling corresponding to only the second codeword in the first codeword group corresponding to the first semi-persistent transmission, the first node receives the first signal and abandons receiving the second signal; and when the first signaling is used for releasing scheduling corresponding to the first codeword and scheduling corresponding to the second codeword corresponding to the first semi-persistent transmission, the first node abandons receiving the first signal and abandons receiving the second signal.

According to one aspect of the present application, comprising:
abandoning sending at least a second signal in a first signal and the second signal,
wherein the first semi-persistent transmission configured by the first information block comprises the first signal and the second signal, the first signal corresponds to the first codeword, and the second signal corresponds to the second codeword; when the first signaling is used for releasing scheduling corresponding to only the second codeword in the first codeword group corresponding to the first semi-persistent transmission, the first node sends the first signal and abandons sending the second signal; and when the first signaling is used for releasing scheduling corresponding to the first codeword and scheduling corresponding to the second codeword corresponding to the first semi-persistent transmission, the first node abandons sending the first signal and abandons sending the second signal.

According to one aspect of the present application, comprising:
receiving second signaling, wherein the second signaling is used for activating scheduling corresponding to the first codeword and scheduling corresponding to the second codeword corresponding to the first semi-persistent transmission,
wherein the second signaling comprises a third field, the third field included in the second signaling and one field in the first field set are the same type of field, and the third field is used for activating PDCCH validation for common scheduling of the first codeword and the second codeword.

As one embodiment, the above method is characterized in that: when one semi-persistent transmission supporting two codewords is activated, the two codewords are both activated to simplify an implementation mode.

The present application discloses a method used in a second node for wireless communication, comprising:
sending a first information block, wherein the first information block is used for configuring a first semi-persistent transmission, the first semi-persistent transmission corresponds to a first codeword group, and the first codeword group comprises a first codeword and a second codeword;
and sending first signaling, wherein the first signaling is used for releasing scheduling corresponding to at least the second codeword in the first codeword group corresponding to the first semi-persistent transmission,
wherein the first signaling comprises a first field set, and the first field set is used for PDCCH validation of scheduling release corresponding to at least the second codeword in the first codeword group corresponding to the first semi-persistent transmission; and the first field set is associated with the first codeword and the second codeword.

According to one aspect of the present application, the first field set comprises a first field; when a first condition is met, PDCCH validation of scheduling release corresponding to only the second codeword in the first codeword group corresponding to the first semi-persistent transmission is achieved; when a second condition is met, PDCCH validation of scheduling release corresponding to the first codeword and PDCCH validation of scheduling release corresponding to the second codeword corresponding to the first semi-persistent transmission are both achieved; the first condition comprises: the first field included in the first field set is equal to a first value; and the second condition comprises: the first field included in the first field set is equal to a second value.

According to one aspect of the present application, the first field set comprises a first field and a second field; when a third condition is met, PDCCH validation of scheduling release corresponding to the first codeword and PDCCH validation of scheduling release corresponding to the second codeword corresponding to the first semi-persistent transmission are both achieved; when a fourth condition is met, PDCCH validation of scheduling release corresponding to only the second codeword in the first codeword group corresponding to the first semi-persistent transmission is achieved; the third condition comprises: the first field and the second field included in the first field set are equal to a first value and a second value, respectively; and the fourth condition comprises: the first field included in the first field set is equal to a first value and the second field is not equal to a second value.

According to one aspect of the present application, the second codeword is predefined in the first codeword group, or high-layer signaling is used for determining the second codeword from the first codeword group.

According to one aspect of the present application, the first signaling comprises a target field, the target field is used for indicating a first index set, the first index set comprises a first index, and the first semi-persistent transmission configured by the first information block is associated with the first index; and the first index set is associated with K1 semi-persistent transmissions, and the first signaling is used for releasing scheduling corresponding to at least one codeword in the first codeword group corresponding to any semi-persistent transmission in the K1 semi-persistent transmissions.

According to one aspect of the present application, comprising:
abandoning sending at least a second signal in a first signal and the second signal,
wherein the first semi-persistent transmission configured by the first information block comprises the first signal and the second signal, the first signal corresponds to the first codeword, and the second signal corresponds to the second codeword; when the first signaling is used for releasing scheduling corresponding to only the second codeword in the first codeword group corresponding to the first semi-persistent transmission, the second node sends the first signal and abandons sending the second signal; when the first signaling is used for releasing scheduling corresponding to the first codeword and scheduling corresponding to the second codeword corresponding to the first semi-persistent transmission, the second node abandons sending the first signal and abandons sending the second signal.

According to one aspect of the present application, comprising:
abandoning receiving at least a second signal in a first signal and the second signal,
wherein the first semi-persistent transmission configured by the first information block comprises the first signal and the second signal, the first signal corresponds to the first codeword, and the second signal corresponds to the second codeword; when the first signaling is used for releasing scheduling corresponding to only the second codeword in the first codeword group corresponding to the first semi-persistent transmission, the second node receives the first signal and abandons receiving the second signal; and when the first signaling is used for releasing scheduling corresponding to the first codeword and scheduling corresponding to the second codeword corresponding to the first semi-persistent transmission, the second node abandons receiving the first signal and abandons receiving the second signal.

According to one aspect of the present application, comprising:
sending second signaling, wherein the second signaling is used for activating scheduling corresponding to the first codeword and scheduling corresponding to the second codeword corresponding to the first semi-persistent transmission,
wherein the second signaling comprises a third field, the third field included in the second signaling and one field in the first field set are the same type of field, and the third field is used for activating PDCCH validation for common scheduling of the first codeword and the second codeword.

The present application discloses a first node for wireless communication, comprising:
a first receiver for receiving a first information block, wherein the first information block is used for configuring a first semi-persistent transmission, the first semi-persistent transmission corresponds to a first codeword group, and the first codeword group comprises a first codeword and a second codeword;
and a first transceiver for receiving first signaling, wherein the first signaling is used for releasing scheduling corresponding to at least the second codeword in the first codeword group corresponding to the first semi-persistent transmission,
wherein the first signaling comprises a first field set, and the first field set is used for PDCCH validation of scheduling release corresponding to at least the second codeword in the first codeword group corresponding to the first semi-persistent transmission; and the first field set is associated with the first codeword and the second codeword.

The present application discloses a second node for wireless communication, comprising:
a first transmitter for sending a first information block, wherein the first information block is used for configuring a first semi-persistent transmission, the first semi-persistent transmission corresponds to a first codeword group, and the first codeword group comprises a first codeword and a second codeword;
and a second transceiver for sending first signaling, wherein the first signaling is used for releasing scheduling corresponding to at least the second codeword in the first codeword group corresponding to the first semi-persistent transmission,
wherein the first signaling comprises a first field set, and the first field set is used for PDCCH validation of scheduling release corresponding to at least the second codeword in the first codeword group corresponding to the first semi-persistent transmission; and the first field set is associated with the first codeword and the second codeword.

As one embodiment, the solution in the present application has the advantages of: optimizing a release/activation mode of the grant-free scheduling supporting the two-codeword transmission, improving the flexibility, and avoiding the resource waste, thereby improving the performance.

### BRIEF DESCRIPTION OF THE DRAWINGS

Other features, objects and advantages of the present application will become more apparent by reading the detailed description of non-limiting embodiments with reference to the following drawings:

FIG. 1 shows a processing flowchart of a first node according to one embodiment of the present application;

FIG. 2 shows a schematic diagram of a network architecture according to one embodiment of the present application;

FIG. 3 shows a schematic diagram of an embodiment of a wireless protocol architecture of a user plane and a control plane according to one embodiment of the present application;

FIG. 4 shows a schematic diagram of a first communication device and a second communication device according to one embodiment of the present application;

FIG. 5 shows a flowchart of first signaling according to one embodiment of the present application;

FIG. 6 shows a flowchart of first signaling according to another embodiment of the present application;

FIG. 7 shows a flowchart of second signaling according to one embodiment of the present application;

FIG. 8 shows a schematic diagram of first signaling according to one embodiment of the present application;

FIG. 9 shows a schematic diagram of a first information block according to one embodiment of the present application;

FIG. 10 shows a schematic diagram of a first node according to one embodiment of the present application;

FIG. 11 shows a schematic diagram of an antenna port and an antenna port group according to one embodiment of the present application;

FIG. 12 shows a structural block diagram of a processing device in a first node device according to one embodiment of the present application; and

FIG. 13 shows a structural block diagram of a processing device in a second node device according to one embodiment of the present application.

### DETAILED DESCRIPTION OF EMBODIMENTS

The technical solution of the present application will be further described in detail below in conjunction with the accompanying drawings. It should be noted that the embodiments and features in the embodiments in the present application can be arbitrarily combined with each other in case of no conflict.

### Embodiment 1

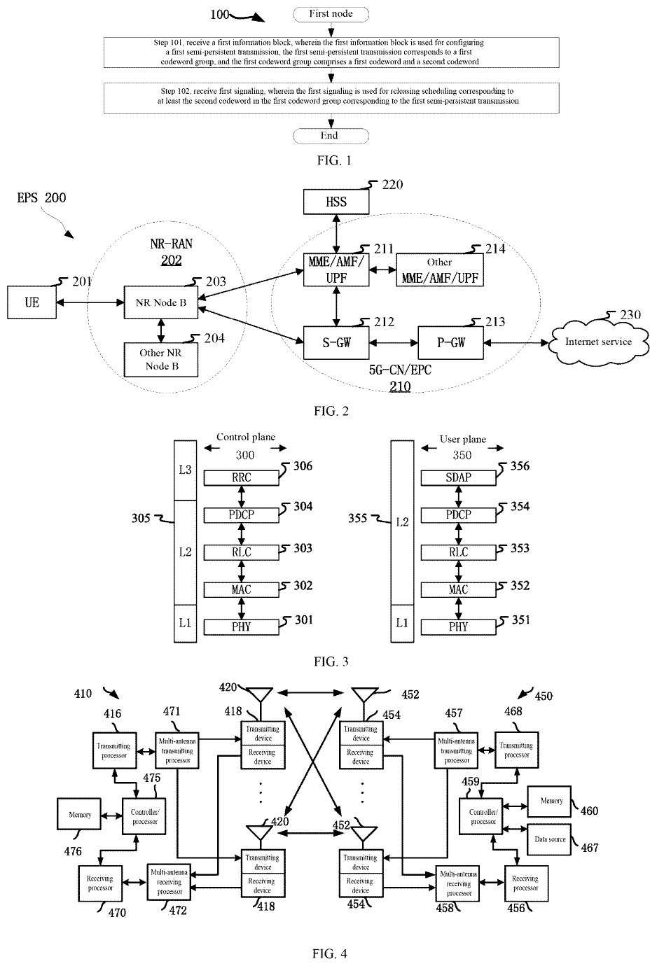

Embodiment 1 illustrates a processing flowchart of one first node, as shown in FIG. 1. In 100 shown in FIG. 1, each block represents one step. In Embodiment 1, the first node in the present application receives a first information block in step 101, wherein the first information block is used for configuring a first semi-persistent transmission, the first semi-persistent transmission corresponds to a first codeword group, and the first codeword group comprises a first codeword and a second codeword; and in step 102, first signaling is received, wherein the first signaling is used for releasing scheduling corresponding to at least the second codeword in the first codeword group corresponding to the first semi-persistent transmission.

In Embodiment 1, the first signaling comprises a first field set, and the first field set is used for PDCCH validation of scheduling release corresponding to at least the second codeword in the first codeword group corresponding to the first semi-persistent transmission; and the first field set is associated with the first codeword and the second codeword.

As one embodiment, the first information block is transmitted through RRC signaling.

As one embodiment, the first information block comprises one or more IEs (Information Elements) in TS 38.331.

As one embodiment, the first information block comprises one or more fields in an SPS-Config IE in TS 38.331.

As one embodiment, the first information block comprises one or more fields in a ConfiguredGrantConfig IE in TS 38.331.

As one embodiment, a name of RRC signaling used for transmitting the first information block comprises SPS (Semi-persistent Scheduling).

As one embodiment, the name of RRC signaling used for transmitting the first information block comprises Configured Grant.

As one embodiment, the name of RRC signaling used for transmitting the first information block comprises Config.

As one embodiment, the first semi-persistent transmission corresponds to multiple downlink transmissions (DL Transmissions).

As one embodiment, the first semi-persistent transmission corresponds to multiple uplink transmissions (UL Transmissions).

As one embodiment, the first semi-persistent transmission corresponds to multiple PDSCHs (Physical Downlink Shared Channels).

As one embodiment, the first semi-persistent transmission corresponds to multiple PUSCHs (Physical Uplink Shared Channels).

As one embodiment, the first semi-persistent transmission corresponds to a first index, and the first index is used for identifying the first semi-persistent transmission.

As one embodiment, the first semi-persistent transmission does not comprise dynamic scheduling.

As one embodiment, the first semi-persistent transmission does not comprise dynamic grant.

As one embodiment, the first semi-persistent transmission corresponds to one SPS-ConfigIndex.

As one embodiment, the first semi-persistent transmission corresponds to one configuredGrantConfigIndex.

As one embodiment, the first semi-persistent transmission corresponds to one configuredGrantConfigIndexMAC.

As one embodiment, the first codeword corresponds to Codeword 1.

As one embodiment, the second codeword corresponds to Codeword 2.

As one embodiment, the first codeword corresponds to a transmission of one or more TBs (Transport Blocks).

As one embodiment, the second codeword corresponds to a transmission of one or more TBs.

As one embodiment, the first codeword is associated with a first reference signal resource set, and the second codeword is associated with a second reference signal resource set.

As one sub-embodiment of this embodiment, the first reference signal resource set and the second reference signal resource set are different.

As one sub-embodiment of this embodiment, the first reference signal resource set corresponds to one SRS (Sounding Reference Signal) resource set.

As one sub-embodiment of this embodiment, the second reference signal resource set corresponds to one SRS resource set.

As one sub-embodiment of this embodiment, the first reference signal resource set corresponds to one SRI (Sounding Reference Signal Resource Indicator).

As one sub-embodiment of this embodiment, the second reference signal resource set corresponds to one SRI.

As one sub-embodiment of this embodiment, the first reference signal resource set corresponds to one Panel.

As one sub-embodiment of this embodiment, the second reference signal resource set corresponds to one Panel.

As one sub-embodiment of this embodiment, the first reference signal resource set corresponds to one CSI-RS (Channel State Information Reference Signal) resource set.

As one sub-embodiment of this embodiment, the second reference signal resource set corresponds to one CSI-RS resource set.

As one sub-embodiment of this embodiment, the first reference signal resource set corresponds to one SSB (SS/PBCH Block, synchronization signal/physical broadcast channel block).

As one sub-embodiment of this embodiment, the second reference signal resource set corresponds to one SSB.

As one sub-embodiment of this embodiment, the first reference signal resource set comprises at least one SRS resource.

As one sub-embodiment of this embodiment, the second reference signal resource set comprises at least one SRS resource.

As one sub-embodiment of this embodiment, a wireless signal corresponding to the first codeword and at least one reference signal resource included in the first reference signal resource set are QCL (Quasi Co-located).

As one sub-embodiment of this embodiment, a wireless signal corresponding to the second codeword and at least one reference signal resource included in the second reference signal resource set are QCL.

As one embodiment, the first semi-persistent transmission corresponds to the first codeword and the second codeword.

As one embodiment, the first semi-persistent transmission comprises a wireless signal corresponding to the first codeword and a wireless signal corresponding to the second codeword.

As one embodiment, the first signaling comprises DCI (Downlink Control Information).

As one embodiment, a physical layer channel occupied by the first signaling comprises a PDCCH.

As one embodiment, the first signaling comprises MAC (Medium Access Control) CEs (Control Elements).

As one embodiment, CRC (Cyclic Redundancy Check) included in the first signaling is scrambled by a CS-RNTI (Configured Grant Radio Network Temporary Identity).

As one embodiment, CRC included in the first signaling is scrambled by an SP-CSI-RNTI (Semi-persistent Channel State Information Radio Network Temporary Identity).

As one embodiment, CRC included in the first signaling is scrambled by an RNTI (Radio Network Temporary Identity) other than a C-RNTI (Cell Radio Network Temporary Identity).

As one embodiment, the first field set comprises multiple fields.

As one embodiment, the first field set comprises only one field.

As one embodiment, the first field set comprises a HARQ (Hybrid Automatic Repeat reQuest) process number field, an RV (Redundancy Version) field, an MCS (Modulation and coding scheme) field, and an FDRA (Frequency Domain Resource Allocation) field.

As one embodiment, the first field set comprises at least one of a HARQ process number field, an RV field, an MCS field, or an FDRA field.

As one embodiment, the first field set comprises an RV field, an MCS field, and an FDRA field.

As one embodiment, the first field set comprises at least one of an RV field, an MCS field, or an FDRA field.

As one embodiment, when the first semi-persistent transmission does not correspond to an SPS-ConfigIndex, the first field set comprises a HARQ process number field; and when the first semi-persistent transmission corresponds to one SPS-ConfigIndex, the first field set does not comprise a HARQ process number field.

As one embodiment, when the first semi-persistent transmission does not correspond to one configuredGrantConfigIndex, the first field set comprises a HARQ process number field; and when the first semi-persistent transmission corresponds to one configuredGrantConfigIndex, the first field set does not comprise a HARQ process number field.

As one embodiment, when the first semi-persistent transmission does not correspond to one configuredGrantConfigIndexMAC, the first field set comprises a HARQ process number field; and when the first semi-persistent transmission corresponds to one configuredGrantConfigIndexMAC, the first field set does not comprise a HARQ process number field.

As one embodiment, the first field set is used for PDCCH validation of scheduling release corresponding to the second codeword in the first codeword group corresponding to the first semi-persistent transmission.

As one embodiment, the first field set is used for PDCCH validation of scheduling release corresponding to the first codeword and PDCCH validation of scheduling release corresponding to the second codeword in the first codeword group corresponding to the first semi-persistent transmission.

As one embodiment, the meaning of “the first field set is associated with the first codeword and the second codeword” comprises: at least one field in the first field set is used for PDCCH validation for scheduling activation of the first codeword and PDCCH validation for scheduling activation of the second codeword.

As one embodiment, the meaning of “the first field set is associated with the first codeword and the second codeword” comprises: the first field set is used for PDCCH validation for scheduling release of the first codeword and PDCCH validation for scheduling release of the second codeword.

### Embodiment 2

Embodiment 2 illustrates a schematic diagram of a network architecture, as shown in FIG. 2.

FIG. 2 illustrates a figure of a network architecture 200 of 5G NR, LTE (Long-Term Evolution) and LTE-A (Long-Term Evolution Advanced) systems. The 5G NR or LTE network architecture 200 may be referred to as an EPS (Evolved Packet System) 200 or some other suitable terms. The EPS 200 may comprise one piece of UE (User Equipment) 201, an NR-RAN (Next Generation Radio Access Network) 202, an EPC (Evolved Packet Core)/5G-CN (5G-Core Network) 210, an HSS (Home Subscriber Server) 220 and an Internet service 230. The EPS can be interconnected with other access networks, but these entities/interfaces are not shown for simplicity. As shown in the figure, the EPS provides a packet switching service. However, those skilled in the art will readily understand that various concepts presented throughout the present application can be extended to networks or other cellular networks that provide a circuit switching service. The NR-RAN comprises an NR Node B (gNB) 203 and other gNB204. The gNB203 provides user and control plane protocol termination toward the UE201. The gNB203 may be connected to the other gNB204 via an Xn interface (for example, backhaul). The gNB203 may also be referred to as a base station, a base station transceiving station, a radio base station, a radio transceiver, a transceiver function, a basic service set (BSS), an extended service set (ESS), a TRP (Transmitter Receiver Point), or some other suitable terms. The gNB203 provides the UE201 with an access point to the EPC/5G-CN 210. Examples of the UE201 comprise cellular phones, smart phones, session initiation protocol (SIP) phones, laptop computers, personal digital assistants (PDAs), satellite radios, non-terrestrial base station communications, satellite mobile communications, global positioning systems, multimedia devices, video devices, digital audio players (e.g., MP3 players), cameras, game consoles, drones, aircrafts, narrowband Internet of Things devices, machine type communication devices, land vehicles, cars, wearable devices, or any other similar functional devices. Those skilled in the art may also refer to the UE201 as a mobile station, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms. The gNB203 is connected to the EPC/5G-CN 210 through an S1/NG interface. The EPC/5G-CN 210 comprises an MME (Mobility Management Entity)/AMF (Authentication Management Field)/UPF (User Plane Function) 211, other MME/AMF/UPF214, an S-GW (Service Gateway) 212, and a P-GW (Packet Data Network Gateway) 213. The MME/AMF/UPF211 is a control node that processes signaling between the UE201 and the EPC/5G-CN 210. Generally, the MME/AMF/UPF211 provides carrying and connection management. All user IP (Internet Protocol) packets are transmitted through the S-GW212, and the S-GW212 itself is connected to the P-GW213. The P-GW213 provides UE IP address allocation and other functions. The P-GW213 is connected to the Internet service 230. The Internet service 230 comprises an Internet protocol service corresponding to operators, which may specifically comprise Internet, intranet, an IMS (IP Multimedia Subsystem), and a packet switching streaming service.

As one embodiment, the UE201 corresponds to the first node in the present application.

As one embodiment, the UE201 supports simultaneous sending of multiple Panels.

As one embodiment, the UE201 supports sending in the same time-frequency resource set based on multiple codewords.

As one embodiment, the UE201 supports multiple uplink RFs (Radio Frequencies).

As one embodiment, the UE201 supports simultaneous sending of multiple uplink RFs.

As one embodiment, the UE201 supports reporting of multiple UE capability value sets.

As one embodiment, the NR Node B corresponds to the second node in the present application.

As one embodiment, the NR node B supports simultaneous reception of signals of multiple Panels from one terminal.

As one embodiment, the NR Node B supports reception of signals sent by multiple uplink RFs (Radio Frequencies) from the same terminal.

As one embodiment, the NR Node B is one base station.

As one embodiment, the NR Node B is one cell.

As one embodiment, the NR Node B comprises multiple cells.

As one embodiment, the first node in the present application corresponds to the UE201, and the second node in the present application corresponds to the NR Node B.

### Embodiment 3

Embodiment 3 shows a schematic diagram of an embodiment of a wireless protocol architecture of one user plane and one control plane according to the present application, as shown in FIG. 3. FIG. 3 is a schematic diagram illustrating an embodiment of a radio protocol architecture of a user plane 350 and a control plane 300. FIG. 3 shows a radio protocol architecture of the control plane 300 between a first communication node device (UE, gNB or RSU in V2X) and a second communication node device (gNB, UE or RSU in V2X) using three layers: Layer 1, Layer 2, and Layer 3. The Layer 1 (L1 layer) is the lowest layer and implements various PHY (physical layer) signal processing functions. The L1 layer will be referred to as PHY301 herein. The Layer 2 (L2 layer) 305 is above the PHY301, and is responsible for a link between the first communication node device and the second communication node device through the PHY301. The L2 layer 305 comprises a MAC (Medium Access Control) sub-layer 302, an RLC (Radio Link Control) sub-layer 303, and a PDCP (Packet Data Convergence Protocol) sub-layer 304, and these sub-layers terminate at the second communication node device. The PDCP sub-layer 304 provides multiplexing between different radio bearers and logical channels. The PDCP sub-layer 304 also provides security through encrypted data packets, and the PDCP sub-layer 304 also provides cross-region mobile support of the first communication node device to the second communication node device. The RLC sub-layer 303 provides segmentation and reassembly of upper layer data packets, retransmission of lost data packets, and reordering of data packets to compensate for disordered reception caused by HARQ. The MAC sub-layer 302 provides multiplexing between logical and transmission channels. The MAC sub-layer 302 is also responsible for allocating various radio resources (for example, resource blocks) in one cell among the first communication node devices. The MAC sub-layer 302 is also responsible for HARQ operations. An RRC (Radio Resource Control) sub-layer 306 in the Layer 3 (L3 layer) in the control plane 300 is responsible for obtaining radio resources (i.e., radio bearers) and configuring a lower layer using RRC signaling between the second communication node device and the first communication node device. The radio protocol architecture of the user plane 350 comprises the Layer 1 (L1 layer) and the Layer 2 (L2 layer). Regarding the radio protocol architecture used for the first communication node device and the second communication node device in the user plane 350, a physical layer 351, a PDCP sub-layer 354 in the L2 layer 355, an RLC sub-layer 353 in the L2 layer 355 and a MAC sub-layer 352 in the L2 layer 355 are generally the same as the corresponding layers and sub-layers in the control plane 300, but the PDCP sub-layer 354 also provides header compression for upper layer data packets to reduce radio transmitting overhead. The L2 layer 355 in the user plane 350 also comprises an SDAP (Service Data Adaptation Protocol) sub-layer 356, and the SDAP sub-layer 356 is responsible for mapping between a QoS stream and a data radio bearer (DRB) to support service diversity. Although not shown, the first communication node device may have several upper layers above the L2 layer 355, including a network layer (for example, IP layer) terminated at P-GW on a network side and an application layer terminated at the other end of connection (for example, a remote UE, server, etc.).

As one embodiment, the wireless protocol architecture in FIG. 3 is applicable to the first node in the present application.

As one embodiment, the wireless protocol architecture in FIG. 3 is applicable to the second node in the present application.

As one embodiment, the PDCP304 of the second communication node device is used for generating scheduling of the first communication node device.

As one embodiment, the PDCP354 of the second communication node device is used for generating scheduling of the first communication node device.

As one embodiment, the first information block is generated in the RRC306.

As one embodiment, the first signaling is generated in the PHY301 or the PHY351.

As one embodiment, the first signaling is generated in the MAC302 or MAC352.

As one embodiment, the first signal is generated in the MAC302 or MAC352.

As one embodiment, the first signal is generated in the RRC306.

As one embodiment, the second signal is generated in the MAC302 or MAC352.

As one embodiment, the second signal is generated in the RRC306.

As one embodiment, the second signaling is generated in the PHY301 or the PHY351.

As one embodiment, the second signaling is generated in the MAC302 or MAC352.

As one embodiment, the first node is one terminal.

As one embodiment, the first node is one relay.

As one embodiment, the second node is one relay.

As one embodiment, the second node is one base station.

As one embodiment, the second node is one gNB.

As one embodiment, the second node is one TRP (Transmitter Receiver Point).

As one embodiment, the second node is used for managing multiple TRPs.

As one embodiment, the second node is a node for managing a plurality of cells.

### Embodiment 4

Embodiment 4 shows a schematic diagram of a first communication device and a second communication device according to the present application, as shown in FIG. 4. FIG. 4 is a block diagram of a first communication device 450 and a second communication device 410 that communicate with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitting device/receiving device 454, and an antenna 452.

The second communication device 410 comprises a controller/processor 475, a memory 476, a receiving processor 470, a transmitting processor 416, a multi-antenna receiving processor 472, a multi-antenna transmitting processor 471, a transmitting device/receiving device 418, and an antenna 420.

In a transmission from the second communication device 410 to the first communication device 450, at the second communication device 410, upper layer data packets from a core network are provided to the controller/processor 475. The controller/processor 475 implements the functionality of the L2 layer. In a transmission from the second communication device 410 to the first communication device 450, the controller/processor 475 provides header compression, encryption, packet segmentation and reordering, multiplexing between logic and transport channels, and radio resource allocation for the first communication device 450 based on various priority measurements. The controller/processor 475 is also responsible for re-transmitting of lost packets and signaling to the first communication device 450. The transmitting processor 416 and the multi-antenna transmitting processor 471 implement various signal processing functions for the L1 layer (that is, physical layer). The transmitting processor 416 implements encoding and interleaving to facilitate forward error correction (FEC) at the second communication device 410, and mapping of signal clusters based on various modulation schemes (for example, Binary Phase Shift Keying (BPSK), Quadrature Phase Shift Keying (QPSK), M-Phase Shift Keying (M-PSK), and M-Quadrature Amplitude Modulation (M-QAM)). The multi-antenna transmitting processor 471 performs digital spatial precoding on encoded and modulated symbols, including codebook-based precoding and non-codebook-based precoding, and beamforming processing, to generate one or more spatial streams. The transmitting processor 416 then maps each spatial stream to a subcarrier, multiplexes with a reference signal (e.g., pilot frequency) in a time domain and/or a frequency domain, and then uses a Fast Fourier Inverse Transform (IFFT) to generate a physical channel carrying a time domain multi-carrier symbol stream. The multi-antenna transmitting processor 471 then performs sending analog precoding/beamforming operations on the time domain multi-carrier symbol stream. Each transmitting device 418 converts a baseband multi-carrier symbol stream provided by the multi-antenna transmitting processor 471 into a radio frequency stream, and then provides the radio frequency stream to different antennas 420.

In a transmission from the second communication device 410 to the first communication device 450, at the first communication device 450, each receiving device 454 receives a signal through its corresponding antenna 452. Each receiving device 454 recovers information modulated to the radio frequency carrier and converts the radio frequency stream into a baseband multi-carrier symbol stream to provide it to the receiving processor 456. The receiving processor 456 and the multi-antenna receiving processor 458 implement various signal processing functions of the L1 layer. The multi-antenna receiving processor 458 performs receiving analog precoding/beamforming operations on the baseband multi-carrier symbol stream from the receiving device 454. The receiving processor 456 uses Fast Fourier Transform (FFT) to convert the baseband multi-carrier symbol stream after the receiving analog precoding/beamforming operations from the time domain to the frequency domain. In the frequency domain, physical layer data signals and reference signals are demultiplexed by the receiving processor 456, wherein the reference signals are used for channel estimation, and the data signals undergo multi-antenna detection in the multi-antenna receiving processor 458 to recover any spatial stream with the first communication device 450 as the destination. Symbols on each spatial stream are demodulated and recovered in the receiving processor 456, and generate soft decisions. The receiving processor 456 then decodes and deinterleaves the soft decisions to recover upper layer data and control signals transmitted by the second communication device 410 on the physical channel. The upper layer data and control signals are then provided to the controller/processor 459. The controller/processor 459 implements a function of the L2 layer. The controller/processor 459 may be associated with a memory 460 storing program codes and data. The memory 460 may be referred to as a computer-readable medium. In a transmission from the second communication device 410 to the second communication device 450, the controller/processor 459 provides demultiplexing between transport and logical channels, packet reassembly, decryption, header decompression, and control signal processing to recover upper layer data packets from the core network. The upper layer data packets are then provided to all protocol layers above the L2 layer. Various control signals may also be provided to the L3 for L3 processing.

In a transmission from the first communication device 450 to the second communication device 410, at the first communication device 450, the data source 467 is used to provide the upper layer data packets to the controller/processor 459. The data source 467 represents all protocol layers above the L2 layer. Similar to the sending function at the second communication device 410 described in the transmission from the second communication device 410 to the first communication device 450, the controller/processor 459 implements header compression, encryption, packet segmentation and reordering, and multiplexing between logic and transport channels based on wireless resource allocation, to implement L2 layer functions for the user plane and the control plane. The controller/processor 459 is also responsible for re-transmitting of lost packets and signaling to the second communication device 410. The transmitting processor 468 performs modulation mapping and channel coding processing, and the multi-antenna transmitting processor 457 performs digital multi-antenna spatial precoding, comprising codebook-based precoding and non-codebook-based precoding, and beamforming processing, and then the transmitting processor 468 modulates a generated spatial stream into a multi-carrier/single-carrier symbol stream which undergoes analog precoding/beamforming operations in the multi-antenna transmitting processor 457 and then is provided to different antennas 452 via the transmitting device 454. Each transmitting device 454 first converts a baseband symbol stream provided by the multi-antenna transmitting processor 457 into a radio frequency symbol stream, and then supplies the radio frequency symbol stream to the antenna 452.

In a transmission from the first communication device 450 to the second communication device 410, a function at the second communication device 410 is similar to a receiving function at the first communication device 450 described in a transmission from the second communication device 410 to the first communication device 450. Each receiving device 418 receives a radio frequency signal through its corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly implement a function of the L1 layer. The controller/processor 475 implements a function of the L2 layer. The controller/processor 475 may be associated with a memory 476 storing program codes and data. The memory 476 may be referred to as a computer-readable medium. In a transmission from the first communication device 450 to the second communication device 410, the controller/processor 475 provides demultiplexing between transport and logical channels, packet reassembly, decryption, header decompression, and control signal processing to recover upper layer data packets from the UE450. The upper layer data packets from the controller/processor 475 can be provided to the core network.

As one embodiment, the first communication device 450 apparatus comprises: at least one processor and at least one memory, the at least one memory comprising computer program codes; the at least one memory and the computer program codes are configured to be used together with the at least one processor, and the first communication device 450 apparatus at least: first receives a first information block, wherein the first information block is used for configuring a first semi-persistent transmission, the first semi-persistent transmission corresponds to a first codeword group, and the first codeword group comprises a first codeword and a second codeword; and then receives first signaling, wherein the first signaling is used for releasing scheduling corresponding to at least the second codeword in the first codeword group corresponding to the first semi-persistent transmission; the first signaling comprises a first field set, the first field set is used for PDCCH validation of scheduling release corresponding to at least the second codeword in the first codeword group corresponding to the first semi-persistent transmission; and the first field set is associated with the first codeword and the second codeword.

As one embodiment, the first communication device 450 comprises: a memory storing a computer-readable instruction program, wherein the computer-readable instruction program generates an action when executed by at least one processor, and the action comprises: first receiving a first information block, wherein the first information block is used for configuring a first semi-persistent transmission, the first semi-persistent transmission corresponds to a first codeword group, and the first codeword group comprises a first codeword and a second codeword; and then receiving first signaling, wherein the first signaling is used for releasing scheduling corresponding to at least the second codeword in the first codeword group corresponding to the first semi-persistent transmission; the first signaling comprises a first field set, the first field set is used for PDCCH validation of scheduling release corresponding to at least the second codeword in the first codeword group corresponding to the first semi-persistent transmission; and the first field set is associated with the first codeword and the second codeword.

As one embodiment, the second communication device 410 apparatus comprises: at least one processor and at least one memory, the at least one memory comprising computer program codes; the at least one memory and the computer program codes are configured to be used together with the at least one processor. The second communication device 410 apparatus at least: first sends a first information block, wherein the first information block is used for configuring a first semi-persistent transmission, the first semi-persistent transmission corresponds to a first codeword group, and the first codeword group comprises a first codeword and a second codeword; and then sends first signaling, wherein the first signaling is used for releasing scheduling corresponding to at least the second codeword in the first codeword group corresponding to the first semi-persistent transmission; the first signaling comprises a first field set, the first field set is used for PDCCH validation of scheduling release corresponding to at least the second codeword in the first codeword group corresponding to the first semi-persistent transmission; and the first field set is associated with the first codeword and the second codeword.

As one embodiment, the second communication device 410 apparatus comprises: a memory storing a computer-readable instruction program, wherein the computer-readable instruction program generates an action when executed by at least one processor, and the action comprises: first receiving a first information block, wherein the first information block is used for configuring a first semi-persistent transmission, the first semi-persistent transmission corresponds to a first codeword group, and the first codeword group comprises a first codeword and a second codeword; and then sends first signaling, wherein the first signaling is used for releasing scheduling corresponding to at least the second codeword in the first codeword group corresponding to the first semi-persistent transmission; the first signaling comprises a first field set, wherein the first field set is used for PDCCH validation of scheduling release corresponding to at least the second codeword in the first codeword group corresponding to the first semi-persistent transmission; and the first field set is associated with the first codeword and the second codeword.

As one embodiment, the first communication device 450 corresponds to a first node in the present application.

As one embodiment, the second communication device 410 corresponds to a second node in the present application.

As one embodiment, the first communication device 450 is one piece of UE.

As one embodiment, the first communication device 450 is one terminal.

As one embodiment, the first communication device 450 is one relay.

As one embodiment, the second communication device 410 is one base station.

As one embodiment, the second communication device 410 is one relay.

As one embodiment, the second communication device 410 is one network device.

As one embodiment, the second communication device 410 is one serving cell.

As one embodiment, the second communication device 410 is one TRP.

As one embodiment, at least the first four of the antenna 452, the receiving device 454, the multi-antenna receiving processor 458, the receiving processor 456, and the controller/processor 459 are used for receiving a first information block; and at least the first four of the antenna 420, the transmitting device 418, the multi-antenna transmitting processor 471, the transmitting processor 416, and the controller/processor 475 are used for sending the first information block.

As one embodiment, at least the first four of the antenna 452, the receiving device 454, the multi-antenna receiving processor 458, the receiving processor 456, and the controller/processor 459 are used for receiving first signaling; and at least the first four of the antenna 420, the transmitting device 418, the multi-antenna transmitting processor 471, the transmitting processor 416, and the controller/processor 475 are used for sending the first signaling.

As one embodiment, at least the first four of the antenna 452, the receiving device 454, the multi-antenna receiving processor 458, the receiving processor 456, and the controller/processor 459 are used for abandoning receiving at least a second signal in a first signal and the second signal; and at least the first four of the antenna 420, the transmitting device 418, the multi-antenna transmitting processor 471, the transmitting processor 416, and the controller/processor 475 are used for abandoning sending at least the second signal in the first signal and the second signal.

As one embodiment, at least the first four of the antenna 452, the transmitting device 454, the multi-antenna transmitting processor 457, the transmitting processor 468, and the controller/processor 459 are used for abandoning sending the second signal in the first signal and the second signal; and at least the first four of the antenna 420, the receiving device 418, the multi-antenna receiving processor 472, the receiving processor 470, and the controller/processor 475 are used for abandoning receiving the second signal in the first signal and the second signal.

As one embodiment, at least the first four of the antenna 452, the receiving device 454, the multi-antenna receiving processor 458, the receiving processor 456, and the controller/processor 459 are used for receiving second signaling; and at least the first four of the antenna 420, the transmitting device 418, the multi-antenna transmitting processor 471, the transmitting processor 416, and the controller/processor 475 are used for sending the second signaling.

### Embodiment 5

Embodiment 5 illustrates a flowchart of one piece of first signaling, as shown in FIG. 5. In FIG. 5, a first node U1 is in communication with a second node N2 through a wireless link. It is particularly noted that the order in the present embodiment does not limit the order of signal transmissions and the order of implementation in the present application. In case of no conflict, the embodiments, sub-embodiments and dependent embodiments in Embodiment 5 can be applied to Embodiment 6 or Embodiment 7; and on the contrary, in case of no conflict, any embodiment, sub-embodiment and dependent embodiment in Embodiment 6 or Embodiment 7 can be applied to Embodiment 5.

For the first node U1, in step S10, a first information block is received; in step S11, first signaling is received; and in step S12, at least a second signal in a first signal and the second signal is abandoned from being sent.

For the second node N2, in step S20, the first information block is sent; in step S21, the first signaling is sent; and in step S22, at least the second signal in the first signal and the second signal is abandoned from being received.

In Embodiment 5, the first information block is used for configuring a first semi-persistent transmission, the first semi-persistent transmission corresponds to a first codeword group, and the first codeword group comprises a first codeword and a second codeword; the first signaling is used for releasing scheduling corresponding to at least the second codeword in the first codeword group corresponding to the first semi-persistent transmission; the first signaling comprises a first field set, the first field set is used for PDCCH validation of scheduling release corresponding to at least the second codeword in the first codeword group corresponding to the first semi-persistent transmission; the first field set is associated with the first codeword and the second codeword; the first semi-persistent transmission configured by the first information block comprises the first signal and the second signal, the first signal corresponds to the first codeword, and the second signal corresponds to the second codeword; when the first signaling is used for releasing scheduling corresponding to only the second codeword in the first codeword group corresponding to the first semi-persistent transmission, the first node sends the first signal and abandons sending the second signal; and when the first signaling is used for releasing scheduling corresponding to the first codeword and scheduling corresponding to the second codeword corresponding to the first semi-persistent transmission, the first node abandons sending the first signal and abandons sending the second signal.

Typically, the step S12 comprises: abandoning sending the first signal and the second signal, and the step S22 comprises: abandoning receiving the first signal and the second signal.

Typically, the step S12 comprises: abandoning sending the second signal and sending the first signal, and the step S22 comprises: abandoning receiving the second signal and receiving the first signal.

Typically, the first field set comprises a first field; when a first condition is met, PDCCH validation of scheduling release corresponding to only the second codeword in the first codeword group corresponding to the first semi-persistent transmission is achieved; when a second condition is met, PDCCH validation of scheduling release corresponding to the first codeword and PDCCH validation of scheduling release corresponding to the second codeword corresponding to the semi-persistent transmission are both achieved; the first condition comprises: the first field included in the first field set is equal to a first value; and the second condition comprises: the first field included in the first field set is equal to a second value.

As one embodiment, the first field included in the first field set is a HARQ process number field.

As one embodiment, the first field included in the first field set is an RV field.

As one embodiment, the first field included in the first field set is an MCS field.

As one embodiment, the first field included in the first field set is an FDRA field.

As one embodiment, the first value is equal to all “1”, and the second value is equal to all “0”.

As one embodiment, the first value is equal to all “0”, and the second value is equal to all “1”.

As one embodiment, the first value is equal to all “0”, and the second value is configurable.

As one embodiment, the first value is equal to all “1”, and the second value is configurable.

As one embodiment, the second value is equal to all “0”, and the first value is configurable.

As one embodiment, the second value is equal to all “1”, and the first value is configurable.

Typically, the first field set comprises a first field and a second field; when a third condition is met, PDCCH validation of scheduling release corresponding to the first codeword and PDCCH validation of scheduling release corresponding to the second codeword corresponding to the first semi-persistent transmission are both achieved; when a fourth condition is met, PDCCH validation of scheduling release corresponding to only the second codeword in the first codeword group corresponding to the first semi-persistent transmission is achieved; the third condition comprises: the first field and the second field included in the first field set are equal to a first value and a second value, respectively; and the fourth condition comprises: the first field included in the first field set is equal to a first value and the second field is not equal to a second value.

As one embodiment, the first field and the second field included in the first field set are two different fields in the HARQ process number field, the RV field, MCS field and the FDRA field, respectively.

As one embodiment, the first field and the second field included in the first field set are the HARQ process number field and the RV field, respectively.

As one embodiment, the first field and the second field included in the first field set are the HARQ process number field and the MCS field, respectively.

As one embodiment, the first field and the second field included in the first field set are the HARQ process number field and the FDRA field, respectively.

As one embodiment, the first field and the second field included in the first field set are the RV field and the MCS field, respectively.

As one embodiment, the first field and the second field included in the first field set are the RV field and the FDRA field, respectively.

As one embodiment, the first field and the second field included in the first field set are the MCS field and the FDRA field, respectively.

As one embodiment, the first value is equal to all “1”.

As one embodiment, the second value is equal to all “0”.

As one embodiment, the first value is equal to all “0”.

As one embodiment, the second value is equal to all “1”.

As one embodiment, the second value is configurable.

As one embodiment, the first value is configurable.

Typically, the second codeword is predefined in the first codeword group, or high-layer signaling is used for determining the second codeword from the first codeword group.

As one embodiment, the second codeword is predefined in the first codeword group.

As one embodiment, the high-layer signaling is used for determining the second codeword from the first codeword group.

As one embodiment, the high-layer signaling comprises RRC signaling.

As one embodiment, the high-layer signaling comprises a MAC CE.

As one embodiment, the second codeword is a corresponding codeword with a smaller SRI in the first codeword group.

As one embodiment, the second codeword is a corresponding codeword with a smaller SRS resource set index in the first codeword group.

As one embodiment, the second codeword is a corresponding codeword with a smaller CORESET Pool Index in the first codeword group.

As one embodiment, the second codeword is a corresponding codeword with a larger SRI in the first codeword group.

As one embodiment, the second codeword is a corresponding codeword with a larger SRS resource set index in the first codeword group.

As one embodiment, the second codeword is a corresponding codeword with a larger CORESET Pool Index in the first codeword group.

Typically, the first signaling comprises a target field, the target field is used for indicating a first index set, the first index set comprises a first index, and the first semi-persistent transmission configured by the first information block is associated with the first index; and the first index set is associated with K1 semi-persistent transmissions, and the first signaling is used for releasing scheduling corresponding to at least one codeword in the first codeword group corresponding to any semi-persistent transmission in the K1 semi-persistent transmissions.

As one embodiment, the target field included in the first field set is a HARQ process number field.

As one embodiment, the target field included in the first field set is not used for PDCCH validation of scheduling release corresponding to the first codeword group.

As one embodiment, the first index is sps-ConfigIndex.

As one embodiment, the first index is configuredGrantConfigIndex.

As one embodiment, the first index is configuredGrantConfigIndexMAC.

As one embodiment, the first index is one non-negative integer.

As one embodiment, the first signal and the second signal correspond to one UL Grant.

As one embodiment, the first signal and the second signal correspond to one PUSCH.

As one embodiment, the first signal and the second signal correspond to two PUSCHs, respectively.

As one embodiment, the first signal and the second signal correspond to one UL-SCH.

As one embodiment, the first signal and the second signal correspond to two UL-SCHs, respectively.

### Embodiment 6

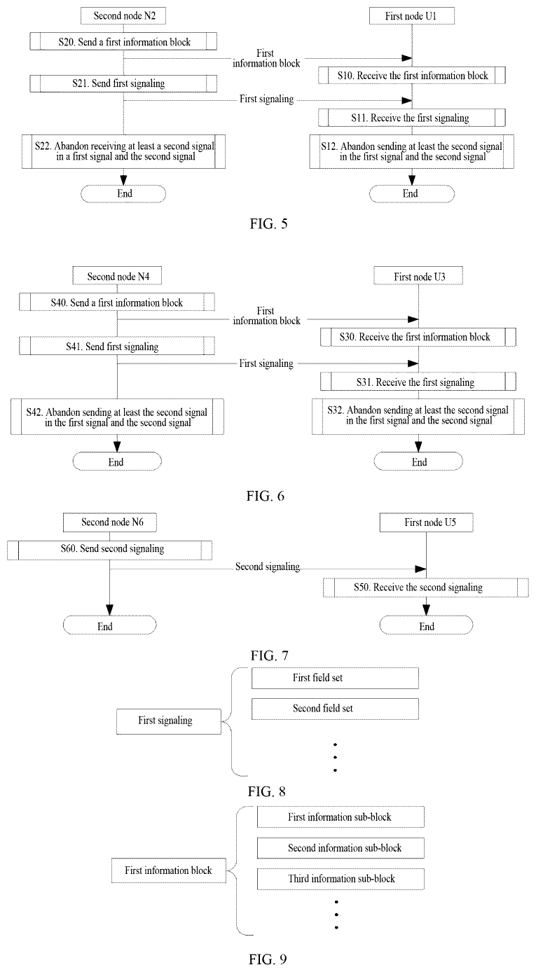

Embodiment 6 illustrates a flowchart of another first signaling, as shown in FIG. 6. In FIG. 6, a first node U3 is in communication with a second node N4 through a wireless link. It is particularly noted that the order in the present embodiment does not limit the order of signal transmissions and the order of implementation in the present application. In case of no conflict, the embodiments, sub-embodiments and dependent embodiments in Embodiment 6 can be applied to Embodiment 5 or Embodiment 7; and on the contrary, in case of no conflict, any embodiment, sub-embodiment and dependent embodiment in Embodiment 5 or Embodiment 7 can be applied to Embodiment 6.

For the first node U3, in step S30, a first information block is received; in step S31, first signaling is received; and in step S32, at least the second signal in the first signal and the second signal is abandoned from being received.

For the second node N4, in step S40, the first information block is sent; in step S41, the first signaling is sent; and in step S42, at least a second signal in a first signal and the second signal is abandoned from being sent.

In Embodiment 6, the first information block is used for configuring a first semi-persistent transmission, the first semi-persistent transmission corresponds to a first codeword group, and the first codeword group comprises a first codeword and a second codeword; the first signaling is used for releasing scheduling corresponding to at least the second codeword in the first codeword group corresponding to the first semi-persistent transmission; the first signaling comprises a first field set, the first field set is used for PDCCH validation of scheduling release corresponding to at least the second codeword in the first codeword group corresponding to the first semi-persistent transmission; the first field set is associated with the first codeword and the second codeword; the first semi-persistent transmission configured by the first information block comprises the first signal and the second signal, the first signal corresponds to the first codeword, and the second signal corresponds to the second codeword; when the first signaling is used for releasing scheduling corresponding to only the second codeword in the first codeword group corresponding to the first semi-persistent transmission, the first node receives the first signal and abandons receiving the second signal; and when the first signaling is used for releasing scheduling corresponding to the first codeword and scheduling corresponding to the second codeword corresponding to the first semi-persistent transmission, the first node abandons receiving the first signal and abandons receiving the second signal.

Typically, the step S32 comprises: abandoning receiving the first signal and the second signal, and the step S42 comprises: abandoning sending the first signal and the second signal.

Typically, the step S32 comprises: abandoning receiving the second signal and receiving the first signal, and the step S42 comprises: abandoning sending the second signal and sending the first signal.

Typically, the first field set comprises a first field; when a first condition is met, PDCCH validation of scheduling release corresponding to only the second codeword in the first codeword group corresponding to the first semi-persistent transmission is achieved; when a second condition is met, PDCCH validation of scheduling release corresponding to the first codeword and PDCCH validation of scheduling release corresponding to the second codeword corresponding to the first semi-persistent transmission are both achieved; the first condition comprises: the first field included in the first field set is equal to a first value; and the second condition comprises: the first field included in the first field set is equal to a second value.

Typically, the first field set comprises a first field and a second field; when a third condition is met, PDCCH validation of scheduling release corresponding to the first codeword and PDCCH validation of scheduling release corresponding to the second codeword corresponding to the first semi-persistent transmission are both achieved; when a fourth condition is met, PDCCH validation of scheduling release corresponding to only the second codeword in the first codeword group corresponding to the first semi-persistent transmission is achieved; the third condition comprises: the first field and the second field included in the first field set are equal to a first value and a second value, respectively; and the fourth condition comprises: the first field included in the first field set is equal to a first value and the second field is not equal to a second value.

Typically, the second codeword is predefined in the first codeword group, or high-layer signaling is used for determining the second codeword from the first codeword group.

Typically, the first signaling comprises a target field, the target field is used for indicating a first index set, the first index set comprises a first index, and the first semi-persistent transmission configured by the first information block is associated with the first index; and the first index set is associated with K1 semi-persistent transmissions, and the first signaling is used for releasing scheduling corresponding to at least one codeword in the first codeword group corresponding to any semi-persistent transmission in the K1 semi-persistent transmissions.

As one embodiment, the first signal and the second signal correspond to one DL Assignment.

As one embodiment, the first signal and the second signal correspond to one PDSCH.

As one embodiment, the first signal and the second signal correspond to two PDSCHs, respectively.

As one embodiment, the first signal and the second signal correspond to one DL-SCH (Downlink Shared Channel).

As one embodiment, the first signal and the second signal correspond to two DL-SCHs, respectively.

### Embodiment 7

Embodiment 7 illustrates a flowchart of one piece of second signaling, as shown in FIG. 7. In FIG. 7, a first node U5 is in communication with a second node N6 through a wireless link. It is particularly noted that the order in the present embodiment does not limit the order of signal transmissions and the order of implementation in the present application. In case of no conflict, the embodiments, sub-embodiments and dependent embodiments in Embodiment 7 can be applied to Embodiment 5 or Embodiment 6; and on the contrary, in case of no conflict, any embodiment, sub-embodiment and dependent embodiment in Embodiment 5 or Embodiment 6 can be applied to Embodiment 7.

For the first node U5, second signaling is received in step S50.

For the second node N6, the second signaling is sent in step S60.

In Embodiment 7, the second signaling is used for activating scheduling corresponding to the first codeword and scheduling corresponding to the second codeword corresponding to the first semi-persistent transmission; the second signaling comprises a third field, the third field included in the second signaling and one field in the first field set are the same type of field, and the third field is used for activating PDCCH validation for common scheduling of the first codeword and the second codeword.

As one embodiment, the second signaling comprises DCI.

As one embodiment, a physical layer channel occupied by the second signaling comprises a PDCCH.

As one embodiment, the second signaling comprises a MAC CE.

As one embodiment, CRC included in the second signaling is scrambled by CS-RNTI.

As one embodiment, CRC included in the second signaling is scrambled by SP-CSI-RNTI.

As one embodiment, CRC included in the second signaling is scrambled by RNTI other than C-RNTI.

As one embodiment, the third field is used for activating PDCCH validation for common scheduling of the first codeword and the second codeword.

As one embodiment, the third field included in the second signaling corresponds to a HARQ process number field.

As one embodiment, the third field included in the second signaling corresponds to an RV field.

As one embodiment, the meaning of “the third field included in the second signaling and one field in the first field set are the same type of field” comprises: the third field included in the second signaling and one field in the first field set correspond to the same name.

### Embodiment 8

Embodiment 8 illustrates a schematic diagram of one piece of first signaling, as shown in FIG. 8. In FIG. 8, the first signaling comprises a first field set, the first field set and a second field set correspond to a first codeword and a second codeword; the first signaling also comprises a second field set, the second field set comprises a first candidate field and a second candidate field, and the first candidate field and the second candidate field correspond to the first codeword and the second codeword, respectively.

As one embodiment, the first candidate field and the second candidate field are both TDRA (Time Domain Resource Allocation) fields.

As one embodiment, the first candidate field and the second candidate field are both DAI (Downlink assignment index) fields.

As one embodiment, the first candidate field and the second candidate field are both TPC (Transmission Power Control) command related fields.

### Embodiment 9

Embodiment 9 illustrates a schematic diagram of one first information block, as shown in FIG. 9. In FIG. 9, the first information block comprises a first information sub-block, a second information sub-block and a third information sub-block, a set of the first information sub-blocks is simultaneously applied to the transmission of the first codeword and the transmission of the second codeword, the second information sub-block is applied to the transmission of the first codeword, and the third information sub-block is applied to the transmission of the second codeword.

As one embodiment, a set of the second information sub-blocks comprises multiple fields in one IE in TS 38.331.

As one embodiment, the second information sub-block corresponds to 1 field in one IE in TS 38.331.

As one embodiment, a set of the third information sub-blocks comprises multiple fields in one IE in TS 38.331.

As one embodiment, the third information sub-block corresponds to 1 field in one IE in TS 38.331.

As one embodiment, the second information sub-block corresponds to an n1PUCCH-AN field in SPS-Config IE in TS 38.331.

As one embodiment, the second information sub-block corresponds to a harq-ProcID-Offset field in an SPS-Config IE in TS 38.331.

As one embodiment, the second information sub-block corresponds to a harq-CodebookID field in an SPS-Config IE in TS 38.331.

As one embodiment, the third information sub-block corresponds to an n1PUCCH-AN field in an SPS-Config IE in TS 38.331.

As one embodiment, the third information sub-block corresponds to a harq-ProcID-Offset field in an SPS-Config IE in TS 38.331.

As one embodiment, the third information sub-block corresponds to a harq-CodebookID field in an SPS-Config IE in TS 38.331.

As one embodiment, the second information sub-block corresponds to an srs-ResourceIndicator field in a ConfiguredGrantConfig IE in TS 38.331.

As one embodiment, the second information sub-block corresponds to an srs-pathlossReferenceIndex field in a ConfiguredGrantConfig IE in TS 38.331.

As one embodiment, the second information sub-block corresponds to a cg-DMRS-Configuration field in a ConfiguredGrantConfig IE in TS 38.331.

As one embodiment, the second information sub-block corresponds to a cg-DMRS-Configuration field in a ConfiguredGrantConfig IE in TS 38.331.

As one embodiment, the second information sub-block corresponds to a p0-PUSCH-Alpha field in a ConfiguredGrantConfig IE in TS 38.331.

As one embodiment, the third information sub-block corresponds to an srs-ResourceIndicator field in a ConfiguredGrantConfig IE in TS 38.331.

As one embodiment, the third information sub-block corresponds to an srs-pathlossReferenceIndex field in a ConfiguredGrantConfig IE in TS 38.331.

As one embodiment, the third information sub-block corresponds to a cg-DMRS-Configuration field in a ConfiguredGrantConfig IE in TS 38.331.

As one embodiment, the third information sub-block corresponds to a cg-DMRS-Configuration field in a ConfiguredGrantConfig IE in TS 38.331.

As one embodiment, the third information sub-block corresponds to a p0-PUSCH-Alpha field in a ConfiguredGrantConfig IE in TS 38.331.

### Embodiment 10

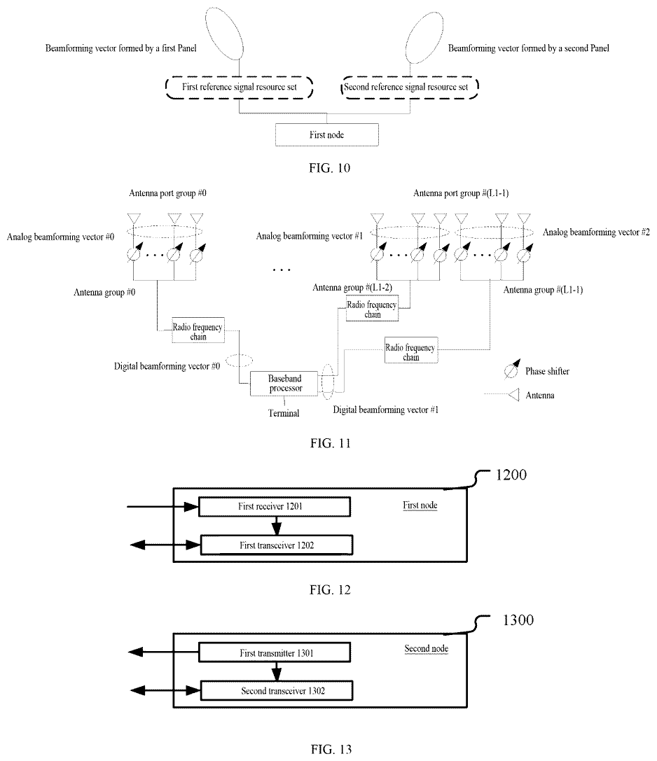

Embodiment 10 illustrates a schematic diagram of one first node, as shown in FIG. 10. In FIG. 10, the first node has two Panels, respectively a first Panel and a second Panel, and the first Panel and the second Panel are respectively used for sending a wireless signal associated with the first codeword and a wireless signal associated with the second codeword; the first Panel and the second Panel are respectively associated with a first reference signal resource set and a second reference signal resource set; and the two Panels are able to send two independent wireless signals in the same time-frequency resource.

As one embodiment, a wireless signal sent in the first Panel and one reference signal resource in the first reference signal resource set are QCL.

As one embodiment, a wireless signal sent in the second Panel and one reference signal resource in the second reference signal resource set are QCL.

### Embodiment 11

Embodiment 11 illustrates a schematic diagram of an antenna port and an antenna port group, as shown in FIG. 11.

In Embodiment 11, one antenna port group comprises a positive integer number of antenna ports; one antenna port is formed by superimposing antennas in a positive integer number of antenna groups through antenna virtualization; and one antenna group comprises a positive integer number of antennas. One antenna group is connected to a baseband processor through one RF (Radio Frequency) chain, and different antenna groups correspond to different RF chains. Mapping coefficients of all antennas in a positive integer number of antenna groups included in a given antenna port to the given antenna port constitute a beamforming vector corresponding to the given antenna port. Mapping coefficients of multiple antennas included in any given antenna group in a positive integer number of antenna groups included in the given antenna port to the given antenna port constitute an analog beamforming vector of the given antenna group. Analog beamforming vectors corresponding to the positive integer number of antenna groups are arranged diagonally to constitute an analog beamforming matrix corresponding to the given antenna port. Mapping coefficients of the positive integer number of antenna groups to the given antenna port constitute a digital beamforming vector corresponding to the given antenna port. A beamforming vector corresponding to the given antenna port is obtained by a product of an analog beamforming matrix and a digital beamforming vector corresponding to the given antenna port. Different antenna ports in one antenna port group are composed of the same antenna group, and different antenna ports in the same antenna port group correspond to different beamforming vectors.

FIG. 11 shows two antenna port groups: an antenna port group #0 and an antenna port group #1. Among them, the antenna port group #0 is composed of an antenna group #0, and the antenna port group #1 is composed of an antenna group #1 and an antenna group #2. Mapping coefficients of multiple antennas in the antenna group #0 to the antenna port group #0 constitute an analog beamforming vector #0, and mapping coefficients of the antenna group #0 to the antenna port group #0 constitute a digital beamforming vector #0. Mapping coefficients of multiple antennas in the antenna group #1 and multiple antennas in the antenna group #2 to the antenna port group #1 respectively constitute an analog beamforming vector #1 and an analog beamforming vector #2, and mapping coefficients of the antenna group #1 and the antenna group #2 to the antenna port group #1 constitute a digital beamforming vector #1. A beamforming vector corresponding to any antenna port in the antenna port group #0 is obtained by a product of the analog beamforming vector #0 and the digital beamforming vector #0. A beamforming vector corresponding to any antenna port in the antenna port group #1 is obtained by a product of an analog beamforming matrix formed by diagonally arranging the analog beamforming vector #1 and the analog beamforming vector #2, and the digital beamforming vector #1.

As one sub-embodiment, one antenna port group comprises one antenna port. For example, the antenna port group #0 in FIG. 9 comprises one antenna port.

As one dependent embodiment of the above sub-embodiment, an analog beamforming matrix corresponding to the one antenna port is dimensionally reduced to an analog beamforming vector, a digital beamforming vector corresponding to the one antenna port is dimensionally reduced to one scalar, and a beamforming vector corresponding to the one antenna port is equal to the analog beamforming vector corresponding to the one antenna port.

As one sub-embodiment, one antenna port group comprises multiple antenna ports. For example, the antenna port group #1 in FIG. 9 comprises multiple antenna ports.

As one dependent embodiment of the above sub-embodiment, the multiple antenna ports correspond to the same analog beamforming matrix and different digital beamforming vectors.

As one sub-embodiment, antenna ports in different antenna port groups correspond to different analog beamforming matrices.

As one sub-embodiment, any two antenna ports in one antenna port group are QCL (Quasi-Colocated).

As one sub-embodiment, any two antenna ports in one antenna port group are spatial QCL.

As one embodiment, multiple antenna port groups in the figure correspond to one Panel in the present application.

As one embodiment, the first reference signal resource set corresponds to multiple antenna port groups.

As one embodiment, the second reference signal resource set corresponds to multiple antenna port groups.

As one embodiment, the first reference signal resource set corresponds to one antenna port group.

As one embodiment, the second reference signal resource set corresponds to one antenna port group.

As one embodiment, one reference signal resource in the first reference signal resource set corresponds to one antenna port group.

As one embodiment, one reference signal resource in the second reference signal resource set corresponds to one antenna port group.

### Embodiment 12

Embodiment 12 illustrates a structural block diagram in one first node, as shown in FIG. 12. In FIG. 12, a first node 1200 comprises a first receiver 1201 and a first transceiver 1202.

The first receiver 1201 receives a first information block, wherein the first information block is used for configuring a first semi-persistent transmission, the first semi-persistent transmission corresponds to a first codeword group, and the first codeword group comprises a first codeword and a second codeword;

the first transceiver 1202 receives first signaling, wherein the first signaling is used for releasing scheduling corresponding to at least one of the first codeword and the second codeword corresponding to the first semi-persistent transmission;
in Embodiment 12, the first signaling comprises a first field set, and the first field set is used for PDCCH validation of scheduling release corresponding to at least the second codeword in the first codeword group corresponding to the first semi-persistent transmission; and the first field set is associated with the first codeword and the second codeword.

As one embodiment, the first field set comprises a first field; when a first condition is met, PDCCH validation of scheduling release corresponding to only the second codeword in the first codeword group corresponding to the first semi-persistent transmission is achieved; when a second condition is met, PDCCH validation of scheduling release corresponding to the first codeword and PDCCH validation of scheduling release corresponding to the second codeword corresponding to the first semi-persistent transmission are both achieved; the first condition comprises: the first field included in the first field set is equal to a first value; and the second condition comprises: the first field included in the first field set is equal to a second value.

As one embodiment, the first field set comprises a first field and a second field; when a third condition is met, PDCCH validation of scheduling release corresponding to the first codeword and PDCCH validation of scheduling release corresponding to the second codeword corresponding to the first semi-persistent transmission are both achieved; when a fourth condition is met, PDCCH validation of scheduling release corresponding to only the second codeword in the first codeword group corresponding to the first semi-persistent transmission is achieved; the third condition comprises: the first field and the second field included in the first field set are equal to a first value and a second value, respectively; and the fourth condition comprises: the first field included in the first field set is equal to a first value and the second field is not equal to a second value.

As one embodiment, the second codeword is predefined in the first codeword group, or high-layer signaling is used for determining the second codeword from the first codeword group.

As one embodiment, the first signaling comprises a target field, the target field is used for indicating a first index set, the first index set comprises a first index, and the first semi-persistent transmission configured by the first information block is associated with the first index; and the first index set is associated with K1 semi-persistent transmissions, and the first signaling is used for releasing scheduling corresponding to at least one codeword in the first codeword group corresponding to any semi-persistent transmission in the K1 semi-persistent transmissions.

As one embodiment, it comprises:
the first transceiver 1202 for abandoning receiving at least a second signal in a first signal and the second signal,
wherein the first semi-persistent transmission configured by the first information block comprises the first signal and the second signal, the first signal corresponds to the first codeword, and the second signal corresponds to the second codeword; when the first signaling is used for releasing scheduling corresponding to only the second codeword in the first codeword group corresponding to the first semi-persistent transmission, the first node receives the first signal and abandons receiving the second signal; and when the first signaling is used for releasing scheduling corresponding to the first codeword and scheduling corresponding to the second codeword corresponding to the first semi-persistent transmission, the first node abandons receiving the first signal and abandons receiving the second signal.

As one embodiment, it comprises:
the first transceiver 1202 for abandoning sending at least a second signal in a first signal and the second signal,
wherein the first semi-persistent transmission configured by the first information block comprises the first signal and the second signal, the first signal corresponds to the first codeword, and the second signal corresponds to the second codeword; when the first signaling is used for releasing scheduling corresponding to only the second codeword in the first codeword group corresponding to the first semi-persistent transmission, the first node sends the first signal and abandons sending the second signal; and when the first signaling is used for releasing scheduling corresponding to the first codeword and scheduling corresponding to the second codeword corresponding to the first semi-persistent transmission, the first node abandons sending the first signal and abandons sending the second signal.

As one embodiment, it comprises:
the first receiver 1201 shown for receiving second signaling, wherein the second signaling is used for activating scheduling corresponding to the first codeword and scheduling corresponding to the second codeword corresponding to the first semi-persistent transmission;
wherein the second signaling comprises a third field, and the third field included in the second signaling and one field in the first field set are the same type of field, and the third field is used for activating PDCCH validation for common scheduling of the first codeword and the second codeword.

As one embodiment, the first receiver 1201 comprises at least the first 4 of an antenna 452, a receiving device 454, a multi-antenna receiving processor 458, a receiving processor 456, and a controller/processor 459 in Embodiment 4.

As one embodiment, the first transceiver 1202 comprises at least the first 6 of an antenna 452, a receiving device/transmitting device 454, a multi-antenna receiving processor 458, a multi-antenna transmitting processor 457, a receiving processor 456, a transmitting processor 468, and a controller/processor 459 in Embodiment 4.

### Embodiment 13

Embodiment 13 illustrates a structural block diagram in one second node, as shown in FIG. 13. In FIG. 13, a second node 1300 comprises a first transmitter 1301 and a second transceiver 1302.

The first transmitter 1301 sends a first information block, wherein the first information block is used for configuring a first semi-persistent transmission, the first semi-persistent transmission corresponds to a first codeword group, and the first codeword group comprises a first codeword and a second codeword;
the second transceiver 1302 sends first signaling, wherein the first signaling is used for releasing scheduling corresponding to at least the second codeword in the first codeword group corresponding to the first semi-persistent transmission;
in Embodiment 13, the first signaling comprises a first field set, and the first field set is used for PDCCH validation of scheduling release corresponding to at least the second codeword in the first codeword group corresponding to the first semi-persistent transmission; and the first field set is associated with the first codeword and the second codeword.

As one embodiment, the first field set comprises a first field; when a first condition is met, PDCCH validation of scheduling release corresponding to only the second codeword in the first codeword group corresponding to the first semi-persistent transmission is achieved; when a second condition is met, PDCCH validation of scheduling release corresponding to the first codeword and PDCCH validation of scheduling release corresponding to the second codeword corresponding to the first semi-persistent transmission are both achieved; the first condition comprises: the first field included in the first field set is equal to a first value; and the second condition comprises: the first field included in the first field set is equal to a second value.

As one embodiment, the first field set comprises a first field and a second field; when a third condition is met, PDCCH validation of scheduling release corresponding to the first codeword and PDCCH validation of scheduling release corresponding to the second codeword corresponding to the first semi-persistent transmission are both achieved; when a fourth condition is met, PDCCH validation of scheduling release corresponding to only the second codeword in the first codeword group corresponding to the first semi-persistent transmission is achieved; the third condition comprises: the first field and the second field included in the first field set are equal to a first value and a second value, respectively; and the fourth condition comprises: the first field included in the first field set is equal to a first value and the second field is not equal to a second value.

As one embodiment, the second codeword is predefined in the first codeword group, or high-layer signaling is used for determining the second codeword from the first codeword group.

As one embodiment, the first signaling comprises a target field, the target field is used for indicating a first index set, the first index set comprises a first index, and the first semi-persistent transmission configured by the first information block is associated with the first index; and the first index set is associated with K1 semi-persistent transmissions, and the first signaling is used for releasing scheduling corresponding to at least one codeword in the first codeword group corresponding to any semi-persistent transmission in the K1 semi-persistent transmissions.

As one embodiment, it comprises:
the second transceiver 1302 for abandoning sending at least the second signal in the first signal and the second signal,
wherein the first semi-persistent transmission configured by the first information block comprises the first signal and the second signal, the first signal corresponds to the first codeword, and the second signal corresponds to the second codeword; when the first signaling is used for releasing scheduling corresponding to only the second codeword in the first codeword group corresponding to the first semi-persistent transmission, the second node sends the first signal and abandons sending the second signal; when the first signaling is used for releasing scheduling corresponding to the first codeword and scheduling corresponding to the second codeword corresponding to the first semi-persistent transmission, the second node abandons sending the first signal and abandons sending the second signal.

As one embodiment, it comprises:
the second transceiver 1302 for abandoning receiving at least the second signal in the first signal and the second signal,
wherein the first semi-persistent transmission configured by the first information block comprises the first signal and the second signal, the first signal corresponds to the first codeword, and the second signal corresponds to the second codeword; when the first signaling is used for releasing scheduling corresponding to only the second codeword in the first codeword group corresponding to the first semi-persistent transmission, the second node receives the first signal and abandons receiving the second signal; and when the first signaling is used for releasing scheduling corresponding to the first codeword and scheduling corresponding to the second codeword corresponding to the first semi-persistent transmission, the second node abandons receiving the first signal and abandons receiving the second signal.

As one embodiment, it comprises:
the first transmitter 1301 for sending second signaling, wherein the second signaling is used for activating scheduling corresponding to the first codeword and scheduling corresponding to the second codeword corresponding to the first semi-persistent transmission,
wherein the second signaling comprises a third field, the third field included in the second signaling and one field in the first field set are the same type of field, and the third field is used for activating PDCCH validation for common scheduling of the first codeword and the second codeword.

As one embodiment, the first transmitter 1301 comprises at least the first 4 of an antenna 420, a transmitting device 418, a multi-antenna transmitting processor 471, a transmitting processor 414, and a controller/processor 475 in Embodiment 4.

As one embodiment, the second transceiver 1302 comprises at least the first 6 of an antenna 420, a receiving device 418, a transmitting device 418, a multi-antenna receiving processor 472, a multi-antenna transmitting processor 471, a transmitting processor 414, a receiving processor 470, and a controller/processor 475 in Embodiment 4.

Those skilled in the art will appreciate that all or some of the steps in the above-mentioned method may be implemented by instructing relevant hardware by a program, and the program can be stored in a computer-readable storage medium, such as a read-only memory, a hard disk or an optical disk, etc. Optionally, all or some of the steps of the above-mentioned embodiments may also be implemented using one or more integrated circuits. Correspondingly, each module unit in the above-mentioned embodiment can be implemented either in a hardware form or in a mode of software functional modules. The present application is not limited to any specific form of combination of hardware and software. The first node in the present application comprises but is not limited to mobile phones, tablet computers, laptops, Internet cards, low-power-consumption devices, eMTC devices, NB-IoT devices, vehicle-mounted communication devices, transportation vehicles, vehicles, RSUs (Road Side Units), aircrafts, airplanes, drones, remote-controlled aircrafts, and other wireless communication devices. The second node in the present application comprises but is not limited to macro cellular base stations, micro cellular base stations, small cellular base stations, home base stations, relay base stations, eNBs, gNBs, transmitting and receiving nodes TRP, GNSSs (Global Navigation Satellite Systems), relay satellites, satellite base stations, air base stations, RSUs, drones, testing devices such as transceiving apparatuses or signaling test instruments that simulate partial base station functions, and other wireless communication devices.

Those skilled in the art will appreciate that the present invention may be practiced in other designated forms without departing from its core or basic features. Therefore, the currently disclosed embodiments should be regarded as descriptive and not restrictive in any way. The scope of the invention is determined by the appended claims rather than the foregoing description, and all modifications within their equivalent meaning and areas are considered to have been included therein.

1. A user equipment (UE) used for wireless communication, the UE comprising:
a transceiver; and
a processor, wherein the transceiver and the processor are configured to:
receive a first information block used for configuring a first semi-persistent transmission, wherein the first semi-persistent transmission corresponds to a first codeword group comprising a first codeword and a second codeword;
receive first signaling used for releasing scheduling corresponding to at least the second codeword in the first codeword group corresponding to the first semi-persistent transmission,
wherein the first signaling comprises a first field set used for Physical Downlink Control Channel (PDCCH) validation of scheduling release corresponding to at least the second codeword in the first codeword group corresponding to the first semi-persistent transmission, and
wherein the first field set is associated with the first codeword and the second codeword.

2. The UE according to claim 1, wherein the first field set comprises a first field, and wherein:
on a condition that_a first condition is met, PDCCH validation of scheduling release corresponding to only the second codeword in the first codeword group corresponding to the first semi-persistent transmission is achieved, wherein the first condition is that the first field included in the first field set is equal to a first value; and
on a condition that a second condition is met, PDCCH validation of scheduling release corresponding to the first codeword and PDCCH validation of scheduling release corresponding to the second codeword corresponding to the first semi-persistent transmission are both achieved, wherein the second condition is that the first field included in the first field set is equal to a second value.

3. The UE according to claim 1, wherein the first field set comprises a first field and a second field; and wherein:
on a condition that a third condition is met, PDCCH validation of scheduling release corresponding to the first codeword and PDCCH validation of scheduling release corresponding to the second codeword corresponding to the first semi-persistent transmission are both achieved, wherein the third condition is that the first field and the second field included in the first field set are equal to a first value and a second value respectively; and
on a condition that a fourth condition is met, PDCCH validation of scheduling release corresponding to only the second codeword in the first codeword group corresponding to the first semi-persistent transmission is achieved wherein the fourth condition is that the first field included in the first field set is equal to a first value and the second field is not equal to a second value.

4. The UE according to claim 1, wherein the second codeword is predefined in the first codeword group, or higher-layer signaling is used for determining the second codeword from the first codeword group.

5. The UE according to claim 1, wherein:
the first signaling comprises a target field used for indicating a first index set comprising a first index, and
the first semi-persistent transmission configured by the first information block is associated with the first index, and
the first index set is associated with K1 semi-persistent transmissions, and
the first signaling is used for releasing scheduling corresponding to at least one codeword in the first codeword group corresponding to any semi-persistent transmission in the K1 semi-persistent transmissions.

6. The UE according to claim 1, wherein the transceiver and the processor are further configured to:
abandon operation of at least a second signal in a first signal and the second signal,
wherein the operation is receiving or the operation is sending, the first semi-persistent transmission configured by the first information block comprises the first signal and the second signal, the first signal corresponds to the first codeword, and the second signal corresponds to the second codeword, and
wherein on a condition that the first signaling is used for releasing scheduling corresponding to only the second codeword in the first codeword group corresponding to the first semi-persistent transmission, the UE performs operation on the first signal and abandons operation of the second signal, and
wherein on a condition that the first signaling is used for releasing scheduling corresponding to the first codeword and scheduling corresponding to the second codeword corresponding to the first semi-persistent transmission, the UE abandons operation of the first signal and abandons operation of the second signal.

7. The UE according to claim 1, wherein the transceiver and the processor are further configured to:
receive second signaling used for activating scheduling corresponding to the first codeword and scheduling corresponding to the second codeword corresponding to the first semi-persistent transmission,
wherein:
the second signaling comprises a third field,
the third field included in the second signaling and one field in the first field set are the same type of field, and
the third field is used for activating PDCCH validation for common scheduling of the first codeword and the second codeword.

8. A base station used for wireless communication, the base station comprising:
a transceiver; and
a processor, wherein the transceiver and the processor are configured to:
send a first information block used for configuring a first semi-persistent transmission, wherein the first semi-persistent transmission corresponds to a first codeword group comprising a first codeword and a second codeword;
send a first signaling used for releasing scheduling corresponding to at least the second codeword in the first codeword group corresponding to the first semi-persistent transmission,
wherein the first signaling comprises a first field set used for Physical Downlink Control Channel (PDCCH) validation of scheduling release corresponding to at least the second codeword in the first codeword group corresponding to the first semi-persistent transmission, and
wherein the first field set is associated with the first codeword and the second codeword.

9. A method used in a user equipment (UE) for wireless communication, the method comprising:
receiving a first information block used for configuring a first semi-persistent transmission, wherein the first semi-persistent transmission corresponds to a first codeword group comprising a first codeword and a second codeword; and
receiving a first signaling used for releasing scheduling corresponding to at least the second codeword in the first codeword group corresponding to the first semi-persistent transmission,
wherein the first signaling comprises a first field set used for Physical Downlink Control Channel (PDCCH) validation of scheduling release corresponding to at least the second codeword in the first codeword group corresponding to the first semi-persistent transmission, and
wherein the first field set is associated with the first codeword and the second codeword.

10. (canceled)

11. The method according to claim 9, wherein the first field set comprises a first field, and wherein:
on a condition that a first condition is met, PDCCH validation of scheduling release corresponding to only the second codeword in the first codeword group corresponding to the first semi-persistent transmission is achieved, wherein the first condition is that the first field included in the first field set is equal to a first value; and
on a condition that a second condition is met, PDCCH validation of scheduling release corresponding to the first codeword and PDCCH validation of scheduling release corresponding to the second codeword corresponding to the first semi-persistent transmission are both achieved, wherein the second condition is that the first field included in the first field set is equal to a second value.

12. The method according to claim 9, wherein the first field set comprises a first field and a second field; and wherein:
on a condition that a third condition is met, PDCCH validation of scheduling release corresponding to the first codeword and PDCCH validation of scheduling release corresponding to the second codeword corresponding to the first semi-persistent transmission are both achieved, wherein the third condition is that the first field and the second field included in the first field set are equal to a first value and a second value respectively; and
on a condition that a fourth condition is met, PDCCH validation of scheduling release corresponding to only the second codeword in the first codeword group corresponding to the first semi-persistent transmission is achieved, wherein the fourth condition is that the first field included in the first field set is equal to a first value and the second field is not equal to a second value.

13. The method according to claim 9, wherein the second codeword is predefined in the first codeword group, or higher-layer signaling is used for determining the second codeword from the first codeword group.

14. The method according to claim 9, wherein:
the first signaling comprises a target field used for indicating a first index set comprising a first index, and
the first semi-persistent transmission configured by the first information block is associated with the first index, and
the first index set is associated with K1 semi-persistent transmissions, and
the first signaling is used for releasing scheduling corresponding to at least one codeword in the first codeword group corresponding to any semi-persistent transmission in the K1 semi-persistent transmissions.

15. The method according to claim 9, further comprising:
abandoning operation of at least a second signal in a first signal and the second signal,
wherein the operation is receiving or the operation is sending, the first semi-persistent transmission configured by the first information block comprises the first signal and the second signal, the first signal corresponds to the first codeword, and the second signal corresponds to the second codeword, and
wherein on a condition that the first signaling is used for releasing scheduling corresponding to only the second codeword in the first codeword group corresponding to the first semi-persistent transmission, the UE performs operation on the first signal and abandons operation of the second signal, and
wherein on a condition that the first signaling is used for releasing scheduling corresponding to the first codeword and scheduling corresponding to the second codeword corresponding to the first semi-persistent transmission, the UE abandons operation of the first signal and abandons operation of the second signal.

16. The method according to claim 9, further comprising:
receiving second signaling used for activating scheduling corresponding to the first codeword and scheduling corresponding to the second codeword corresponding to the first semi-persistent transmission,
wherein:
the second signaling comprises a third field,
the third field included in the second signaling and one field in the first field set are the same type of field, and
the third field is used for activating PDCCH validation for common scheduling of the first codeword and the second codeword.
